(19) United States
(12) Patent Application Publication
(10) Pub. No.: US 2007/0056254 A1
(43) Pub. Date: Mar. 15, 2007

(54) Vehicle equipped with public service air filter

(76) Inventor: William S. Relyea, West Linn, OR (US)

Correspondence Address: Timothy E. Siegel, Suite 206, 1868 Knapps Alley, West Linn, OR, 97068, US

(21) Appl. No.: 11/224,161

(22) Filed: Sep. 12, 2005

(51) Int. Cl. B01D 50/00

(52) U.S. Cl. 55/385.3

(57) ABSTRACT

A motorized vehicle equipped with a public service air filter, comprising an air intake an air filter connected by fluid passageway to said air intake. An air outlet is adapted to exhaust the filtered air outside said motorized vehicle. In one preferred embodiment, a static and high voltage discharge chamber is used to ionize the air. In another preferred embodiment, easily changed filters are used. In another preferred embodiment any combination of above said filtration systems may be used.

### BACKGROUND OF THE INVENTION

Pollution, a major problem throughout the industrialized world has proven stubbornly difficult to address. A great deal of effort has been expended in making motorized vehicles less polluting. This effort has been largely addressed to pollution created by incompletely combusted fuel, which is indeed a major source of air pollution. Unfortunately, it leaves unaddressed the particulates produced by wear of tires, brakes and other particulate matter discharged into the atmosphere by multiple means and sources. In addition, chemical particulates pose a health risk.

These difficult-to-address particulates contribute to respiratory problems experienced by people living in areas of heavy motor vehicle traffic, manufacturing centers, agricultural areas, industrial plants and others. Moreover, it is particulate pollution that tends to be the most visible and that tends to cause the greatest visible air quality degradation of an area. While chemical particulate pollutants are less visible they pose serious hazards, both biologically and physically. In some instances they contribute to the greenhouse effect and global warming. Although society has made great progress in addressing the problems created by exhaust gases, it appears that no practical, global or localized means to combat particulate pollution has been suggested. Furthermore, current studies indicate that respiratory ailments have risen and will continue to rise due to particulate matter inhalation.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

In a first, separate aspect, the present invention may take the form of a motorized vehicle equipped with a public service air filter, comprising air intakes and air filters connected by a passageway to the air intake. An air outlet adapted to exhaust the filtered air outside the motorized vehicle. In one preferred embodiment, a static and high voltage discharge chamber is used to ionize the air. In another preferred embodiment, easily changed air filters are used, in a multi stage design.

In a second separate aspect, the present invention may take the form of a method of combating air pollution caused by motorized vehicles. In this method, motorized vehicles are equipped with public service air filters that take in air and discharge filtered air back into the atmosphere as the motorized vehicles are driven, filtering air as they proceed. The air is collected due to atmospheric pressure created from the forward pressure of the vehicle and the suction or draft created between the roadway and the vehicle. The air is forced into the filtration collection device and discharged into the atmosphere after filtration is achieved.

In a third separate aspect, the present invention may take the form of an electrostatic and high voltage discharge air purifier, comprising an air intake, an electrostatic and high voltage discharge chamber, in fluid communication with the air intake and having an electrostatic and high voltage discharge device. In addition a repository catches ionic particles created by action of the electrostatic and high voltage discharge device.

In addition to the exemplary aspects and embodiments described above, further aspects and embodiments will become apparent by reference to the drawings and by study of the following detailed descriptions.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 is an illustration of a motorized vehicle equipped with a public use air filter according to the present invention.

FIG. 2 is a block diagram of an air filtering system for use in the vehicle of FIG. 1.

### DETAILED DESCRIPTION OF THE PREFERRED EMBODIMENT(S)

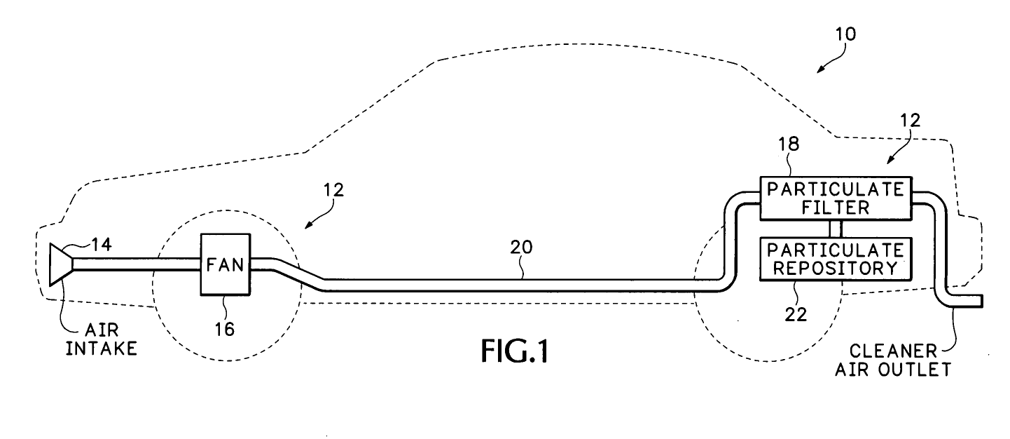

Referring to FIG. 1, the present invention may be manifested in a preferred embodiment as a vehicle 10, equipped with a public service air filtering system 12. Air enters by way of an air intake 14 at the front of the vehicle 10. A fan 16 pushes the air towards the filter 18 by way of fluid passage 20. In another preferred embodiment the air is collected by means of atmospheric pressure created from the motion of the vehicle and the suction or draft created between the roadway and the vehicle. The air is forced into the filtration collection device and discharged back into the atmosphere. The system includes provisions for air intakes in multiple locations throughout the motorized vehicle. A particulate depository 22, easily accessible by way of the car trunk, receives the particles and stores them for easy removal by a vehicle owner or attendant.

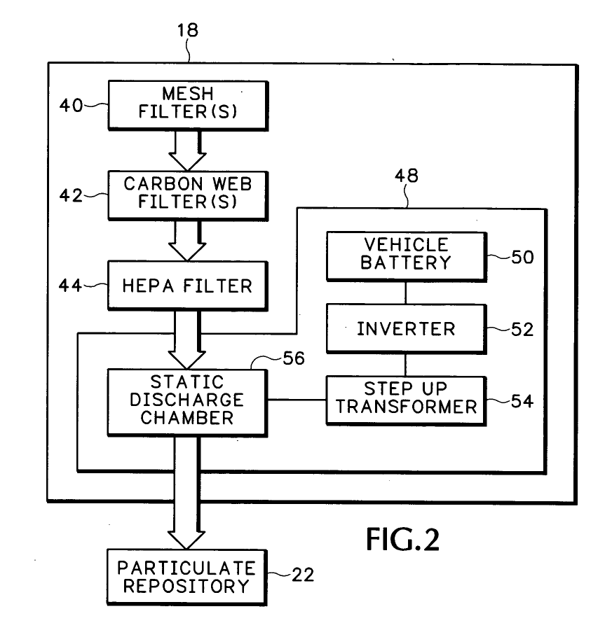

Referring to FIG. 2, in greater detail, air filter 18 may include mesh filters 40, followed by carbon web filters 42 (activated charcoal could also be used), followed by a HEPA filter 44. In addition, a static discharge, ionic filtering system begins with a standard vehicle battery 50, which powers an inverter 52 (producing an AC current). The AC current powers a high voltage transformer system 54 (in one preferred embodiment this includes a flyback transformer). The high voltage output of transformer system 54 is used to create discharges of static electricity in a static discharge chamber 56. These discharges ionize the air, creating ozone, which in turn reacts with fine particulates, making them easier to separate from the rest of the air.

In an alternative preferred embodiment, inexpensive and easy-to-replace filters are used, to clean about 80% to 90% of the particulates from the air. The use of a public service air filter system to improve air quality leads to economies of scale. There are many trade-off points to air filtration systems. The selection includes a more expensive, high efficiency filtering system and a less expensive, easy-to-service system. It might be noted that a system which removes 70% of the particulates from the air would render an improvement that would otherwise be nonexistent.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

1. A motorized vehicle equipped with a public service air filter, comprising:
(a) an air intake;
(b) an air filter connected by fluid passageway to said air intake; and
(c) an air outlet, adapted to exhaust filtered air outside said motorized vehicle.

2. The motorized vehicle of claim 1, wherein said air filter includes an ozone generator and ozone filtering stage.

3. The motorized vehicle of claim 1, wherein said air filter includes an activated charcoal stage.

4. The motorized vehicle of claim 1, wherein said air filter includes a vacuum bag and HEPA stage.

5. The motorized vehicle of claim 1, wherein said air filter includes a static and high voltage electric discharge phase.

6. The motorized vehicle of claim 1, wherein said air filter includes a particulate repository.

7. A method of combating air pollution caused by motorized vehicles, comprising;
(a) equipping motorized vehicles with public service air filters that take in air and discharge filtered air back into the atmosphere; and
(b) driving said motorized vehicles and filtering air.

8. The motorized vehicle of claim 7, wherein said air filter includes an ozone generator and ozone filtering stage.

9. The motorized vehicle of claim 7, wherein said air filter includes an activated charcoal stage.

10. The motorized vehicle of claim 7, wherein said air filter includes a vacuum bag and HEPA stage.

11. The motor vehicle of claim 7, wherein said air filter includes a static electric discharge phase.

12. An electrostatic discharge air purifier, comprising:
(a) an air intake;
(b) an electrostatic discharge chamber, in fluid communication with said air intake and having an electrostatic discharge device; and
(c) a catcher for catching ionic particles created by action of said electrostatic discharge device.
